(19) United States
(12) Patent Application Publication
(10) Pub. No.: US 2007/0083807 A1
(43) Pub. Date: Apr. 12, 2007

(54) Evaluating multiple data filtering expressions in parallel

(75) Inventors: Frederick Ezra Shaudys, Duvall, WA (US); Patrick R. Kenny, Dunstable, MA (US); Raymond W. McCollum, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/245,390

(22) Filed: Oct. 6, 2005

(51) Int. Cl. G06F 17/00

(52) U.S. Cl. 715/513

(57) ABSTRACT

The present invention extends to methods, systems, and computer program products for evaluating multiple data filtering expressions in parallel. A filtering module accesses an XML document containing a plurality of XML elements. The filtering module serializing the XML document into serialized XML. The filtering module accesses a plurality of filtering expressions, each filtering expression corresponding to a component that is potentially interested in receiving the XML document. The filtering module aggregates the plurality of filtering expression into a single equivalent filtering expression. The filtering module evaluates the equivalent filtering expression over the serialized XML in a single pass. The filtering module returns a logical TRUE value for any of the plurality of filtering expressions that are satisfied. The filtering module delivers the XML document to the corresponding component for each of the plurality of filtering expressions that was returned a logical TRUE value.

### CROSS-REFERENCE TO RELATED APPLICATIONS

Not Applicable.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, and database management) that prior to the advent of the computer system were performed manually. More recently, computer systems have been coupled to one another and to other electronic devices to form both wired and wireless computer networks over which the computer systems and other electronic devices can transfer electronic data. As a result, many tasks performed at a computer system (e.g., voice communication, accessing electronic mail, controlling home electronics, Web browsing, and printing documents) include the exchange of electronic messages between a number of computer systems and and/or other electronic devices via wired and/or wireless computer networks.

Extensible Markup Language (“XML”) is flexible text format that can be used to exchange data between computer systems. XML allows application developers to create their own customized tags, enabling the definition, transmission, validation, and interpretation of data between applications and between organizations. For example, computer systems connected to the Internet often use XML to communicate. Even within a single computer system, XML can be used to transfer data between various internal software modules.

For example, in systems with publishers and subscribers, such as, for example, event delivery systems, events can be described as XML documents. Publishers can publish events as XML documents, which are in turn consumed by subscribers. Larger event deliver systems can be used to report large numbers or real-time events (e.g., on the operational state of a computer system) from publishers. However, not all subscribers are typically configured to consume every event. On the other hand, subscribers are typically configured (through registration with an event delivery system) to receive a (usually small) subset of all the events that are published. For example, a disk drive monitoring subscriber is typically only interested in published events related to the performance of disk drives (and not in events related to graphics, user-input devices, audio, etc.)

To match published events to appropriate event subscribers, event delivery systems typically include some type of filtering mechanism. A common mechanism used for XML filtering is the XML Pathing Language (XPath). Generally, XPath can be used to check an XML document to determine if the XML event document satisfies specified criteria. In event delivery systems, XPath can be used to determine if a published XML event document matches criteria provided by event subscribers. When a match is identified, the XML event document is delivered to an event subscriber that provided the matching criteria.

In operation, an event subscriber registers with an event delivery system by providing the event delivery system with criteria indicating events the event subscriber is interested in. Subsequently, when the event delivery system receives an XML event document, the XML event document is parsed and built into a tree structure called a Document Object Model (DOM). Thus, in an event delivery system, a DOM is a tree structure representing an XML event document. The top level of the tree is the top level XML element and further XML sub-elements are included in lower branches of the tree structure. A DOM can also include pointers between different levels of the tree to facilitate navigation between different elements.

XPath expressions can then be used to select relevant pieces of an XML event document for delivery to event subscribers. For example, for each event subscriber, the event deliver system runs an XPath query, with the event subscriber's specified criteria, against the tree structure. XPath queries are typically executed serially (i.e., one after another). As matches are identified, a result set (e.g., relevant portion(s) of an XML event document) can be sent to the corresponding event subscriber. Thus, multiple passes (at least one per registered event subscriber) must be made over a DOM to identify all the event subscribers that are interested in a corresponding XML event document.

Generation of a DOM for an XML document can be advantageous for large portions of XML because it breaks the XML documents down into traversable elements that can be searched. However, creation of a DOM from an XML document is resource intensive. In systems with a high rate of incoming smaller XML documents, these resource requirements can hamper system performance. For example, event delivery systems can generate thousands of XML event documents per second. Creating and maintaining corresponding DOMs can consume significant resources prevent other components from using these resources.

Further, serially evaluation of XPath expressions against a DOM requires the DOM to reside in memory until all evaluations are complete. Thus, to identify event subscribers interested in XML event documents in an event delivery system, corresponding DOMs must be retained in memory while XPath expressions for each event subscriber are evaluated serially over each of the DOMs. As result sets are identified, these result sets must then me transferred to the appropriate event subscriber. Serial evaluation of XPath expressions from potentially thousands of event subscribers over thousands of DOMs is neither time nor resource efficient.

### BRIEF SUMMARY

The present invention extends to methods, systems, and computer program products for evaluating multiple data filtering expressions in parallel. A filtering module accesses an XML document containing a plurality of XML elements. The filtering module serializing the XML document into serialized XML. The filtering module accesses a plurality of filtering expressions, each filtering expression corresponding to a component that is potentially interested in receiving the XML document. The filtering module aggregates the plurality of filtering expression into a single equivalent filtering expression.

The filtering module evaluates the equivalent filtering expression over the serialized XML in a single pass. The filtering module returns a logical TRUE value for any of the plurality of filtering expressions that are satisfied. The filtering module delivers the XML document to the corresponding component for each of the plurality of filtering expressions that was returned a logical TRUE value.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates evaluating multiple data filtering expressions in parallel.

FIG. 2 illustrates a flow chart of a method for evaluating multiple data filtering expressions in parallel.

FIG. 3 illustrates an example computer architecture that facilitates evaluating multiple XPath expressions in parallel in an event delivery system.

### DETAILED DESCRIPTION

The present invention extends to methods, systems, and computer program products for evaluating multiple data filtering expressions in parallel. A computer system accesses an XML document containing a plurality of XML elements. The computer system serializing the XML document into serialized XML. The computer system accesses a plurality of filtering expressions, each filtering expression corresponding to a component that is potentially interested in receiving the XML document. The computer system aggregates the plurality of filtering expression into a single equivalent filtering expression.

The computer system evaluates the equivalent filtering expression over the serialized XML in a single pass. The computer system returns a logical TRUE value for any of the plurality of filtering expressions that are satisfied. The computer delivers the XML document to the corresponding component for each of the plurality of filtering expressions that was returned a logical TRUE value.

Embodiments of the present invention may comprise a special purpose or general-purpose computer including computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, computer-readable media can comprise, computer-readable storage media, such as, RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

In this description and in the following claims, a “network” is defined as one or more data links that enable the transport of electronic data between computer systems and/or modules. When information is transferred or provided over a network or another communications connection (either hardwired, wireless, or a combination of hardwired or wireless) to a computer, the computer properly views the connection as a computer-readable medium. Thus, by way of example, and not limitation, computer-readable media can comprise a network or data links which can be used to carry or store desired program code means in the form of computer-executable instructions or data structures and which can be accessed by a general purpose or special purpose computer.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, laptop computers, hand-held devices, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

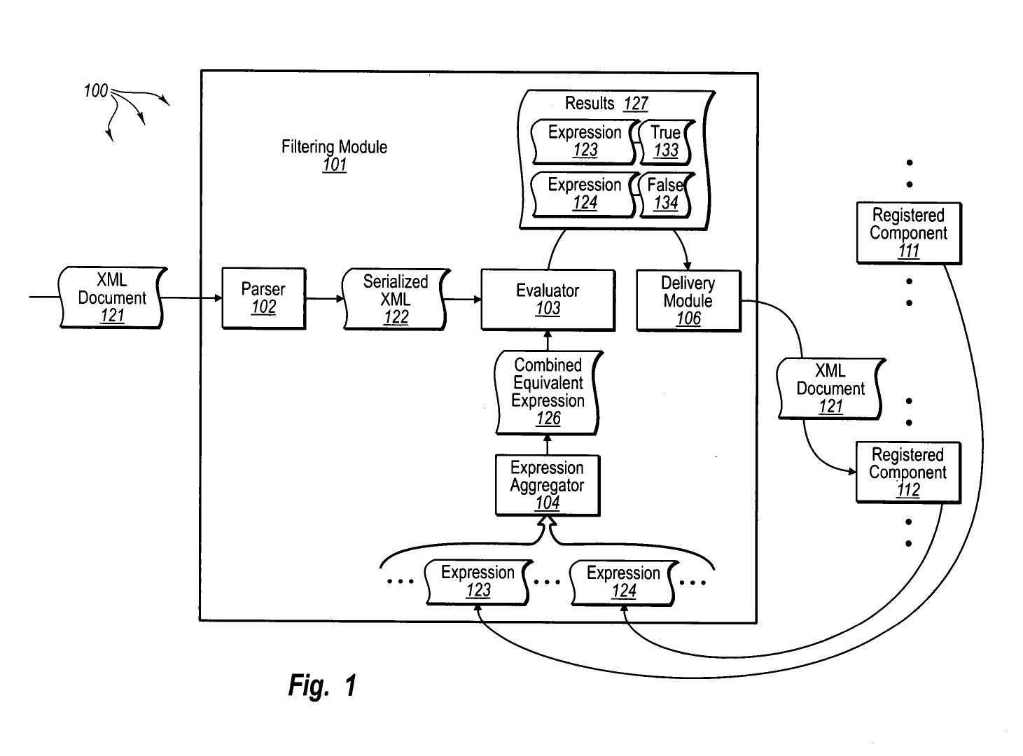

FIG. 1 illustrates an example of a computer architecture 100 that facilitates evaluating multiple data filtering expressions in parallel. Depicted in computer architecture 100 are components of a computer system. The computer system can be connected to a network, such as, for example, a Local Area Network (“LAN”), a Wide Area Network (“WAN”), or even the Internet. Thus, the computer system and other network connect computer systems can receive data from and send data to other computer systems connected to a network. Accordingly, the computer, as well as other connected computer systems (not shown), can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Computer system architecture 100 includes filtering module 101. Generally, filtering module 101 is configured to receive eXstensible Markup Language (“XML”) documents and determine if any components of the computer system are interested in the XML document. For example, filtering module 101 can access XML document 121 and determine if any of the registered components 111 and 112 are interested in XML document 121.

Within filtering module 101, parser 102 is configured to received an XML document and serialize the XML document into serialized XML. In some embodiments, an XML document parser 102 serializes an XML document into a single line of data.

Components of architecture 101 can be associated with expressions that indicate specified data (e.g., contained in XML documents) the components are interested in. Thus, when a component is interested in XML documents containing specified data, the component can send an expression indicative of the specified data to filtering module 101 (e.g., as part of a registration process). Filtering module 101 can receive expressions from components of computer architecture 101 and can retain the received expressions. When an XML document is received, filtering module 101 can utilize retained expressions to determine if an XML document includes data of interest to a component.

Expression aggregator 104 is configured to aggregate expressions into a combined equivalent expression. For example, expression aggregator 104 can receive expressions from various components and can aggregate the received expressions into a single combined equivalent expression representative of the received expressions.

Evaluator 103 is configured to access serialized XML and a combined equivalent expression and evaluate the serialized XML against the combined equivalent expression. The evaluation determines if the serialized XML contains the specified data indicated in any of the received expressions (i.e., if data in the XML document matches the expression). Evaluator 103 is also configured to produce a result for received expressions indicating if the XML document contains data indicated in the received expressions.

Delivery module 106 is configured to receive results and delivery the XML document to components for which the XML document did contain data of interest.

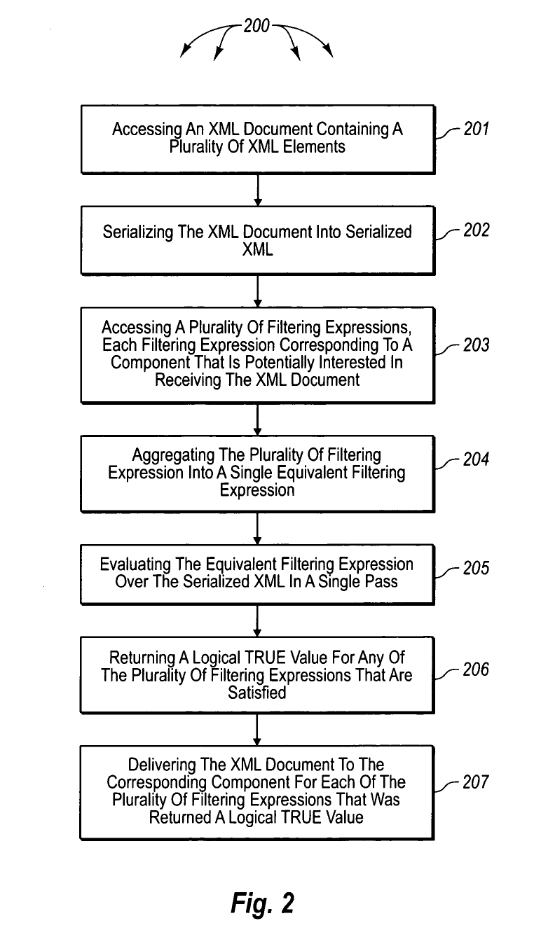

FIG. 2 illustrates a flow chart of a method 200 for evaluating multiple data filtering expressions in parallel. The method 200 will be described with respect to the components and data in computer architecture 100.

Method 200 includes an act of accessing an XML document containing a plurality of XML elements (act 201). For example, parser 102 can access XML document 121. XML document 121 can include XML instructions of the example format:

<element>

.

.

.

<subelement1>
.
.
.

</sublement1>

.

.

.

<subelement2>
.
.
.

</sublement2>

.

.

.

</element>

where a series of three vertical periods (a vertical ellipsis) represents the potential for further nested subelements between the expressly depicted elements.

Method 200 includes an act of serializing the XML document into serialized XML (act 202). For example, parser 102 can serialize XML document 121 into serialized XML 122. XML instructions can be serialized into a single line format similar to:

<element> . . . <subelement 1> . . . </sublement1> . . . <subelement2> . . . </sublement2> . . . </element>

where a series of three periods (an ellipsis) represents any further nested subelements between the expressly depicted elements.

The method 200 includes an act of accessing a plurality of filtering expressions, each filtering expression corresponding to a component that is potentially interested in receiving the XML document (act 203). For example, expression aggregator 104 can access expressions 123 and 124 as well as one or more other expressions corresponding to other components (represented by the ellipsis before, between, and after expressions 123 and 124). Expressions 123 and 124 can be virtually any type of filtering expressions. In some embodiments, expressions 123 124, and any other expressions are XML Pathing Language (XPath) expressions.

Expressions can be provided by and correspond to components of computer architecture 100. For example, expressions 123 and 124 can be provided by and correspond to registered components 111 and 112 respectively. Expression 123 can indicate data of interest to registered component 111 and expression 124 can indicated data of interest to registered component 112. Components can provided expressions to filtering module 101 as part of a registration process to receive data of interest.

Method 200 includes an act of aggregating the plurality of filtering expression into a single equivalent filtering expression (act 204). For example, expression aggregator 104 can aggregate expressions 123, 124 and any other expressions into combined equivalent expression 126. Aggregation rules can be used to aggregate expressions into a combined equivalent expression in a consistent manner. Aggregation rules can define how transformations are to be applied to an expression in aggregate the expression into a combined equivalent expression.

In some embodiments, a plurality of XPath expressions is aggregated into a combined equivalent XPath expression. The plurality of XPath expressions are collectively represented as a tree structure where each node in the tree represents the enclosing scope of some element(s) from the original XPath expression set. The nodes are unique in the set of all possible name scopes. Thus, if one or more XPath expressions refer to the scope a/b/c, then there will be exactly one node representing each of a, a/b, and a/b/c with the obvious parent/child relationships.

The basic transformation of the XPath expressions into this tree structure includes breaking apart an XPath expression into a disjunction of conjunctions (disjunctive normal form). Thus, the transformation transforms an XPath expression from a set operation on the contents of an XML document into a boolean operation on the XML documents as a whole. Each term of a conjunction incudes of two parts: a path from the root node to the node context in which the term is to be evaluated and the boolean term itself.

The following aggregation rules define some example transformations that can be applied to an XPath expression. In the following rules ‘C’ represents the contents of the context node, lowercase letters represent node types, ‘op’ is any operator except those operators whose domain is non-boolean and whose range is boolean, ‘op2’ represents operators whose domain and range are non-boolean, ‘A’ is the value of an atom. and ‘exp#’ is a wildcard for any sub-expression. The operator ˆrepresents a logical ‘and’ operator and the operator ‘v’ represents a logical ‘or’operator in boolean expressions. The example XPath aggregation rules can be defined as follows:

Rules that deal with boolean domains and ranges:

a.) a[exp1]/b[exp2]=>(a, exp1)ˆ(a/b, exp2)

b.) a/b[exp1 and exp2]=>(a/b, exp1)ˆ(a/b, exp2)

c.) a/b[exp1 or exp2]=>(a/b, exp1) v (a/b, exp2)

Rules that deal with non-boolean domains and boolean ranges:

d.) a[b op A]=>(a/b, C op A)

e.) a[exp1 op exp2]=>(a, {a/exp1} op {a/exp2})

Rules that deal with both non-boolean domains and ranges:

f.) a[exp1 op2 exp2]=>(a, {a/exp1} op2 {a/exp2})

g.) a/{expr1 op2 c/exp2}=>{a/expr1} op2 {a/c/exp2}

Rules a, b and c related to transformations of operators that can be directly translated into logical ‘and’ and ‘or’. Notice that ‘/’ becomes equivalent to ‘ˆ’. Rule d is an optimization that can be applied when one of the arguments is an atom. In this case, we can evaluate the operation in the context of b even though the expression occurs in the context of a. Rule e defines that any ‘op’ causes its non-boolean sub-expressions to resolve to a boolean result. Rule f defines that the root of a non-boolean expression eventually becomes a boolean result in the context of some node. Rule g defines that the context of an expression applied to an expression as a whole is propagated to its arguments.

As an example, let a[b<1]/b[@x=2 and (c+d)] be an XPath expression we wish to transform using the above rules. The translation would be: (a/b, C<1) A (a/b, @x=2)ˆ(a/b, {a/b/c}+{a/b/d}). Extending this example with an ‘or’ operator substituted for the ‘and’ above we get: (a/b, C<1)ˆ((a/b, @x=2) v (a/b, {a/b/c}+{a/b/d})). This reduces to (a/b, C<1)ˆ(a/b, @x=2) v (a/b, C<1)ˆ(a/b, {a/b/c}+{a/b/d}).

Also note that boolean portions of a query can be extracted and given to providers that wish to do their own optimization. To derive a purely boolean expression from the normalized form of an XPath expression non-boolean sub-expressions can be replaced with the constant TRUE. The resulting expression is a purely boolean relation that defines a superset of the original expression. For example, (a/b, C<1)ˆ(a/b, @x=2)ˆ(a/b, {a/b/c}+{a/b/d}) would become just, (a/b, C<1)ˆ(a/b, @x=2) because the third term was replaced with TRUE as the outermost expression and eliminated.

Method 200 includes an act of evaluating the equivalent filtering expression over the serialized XML in a single pass (act 205). For example, evaluator 102 can evaluate combined equivalent expression 126 over serialized XML 122 in a single pass.

The evaluation of an XML document (e.g., XML document 121) can include an in-order depth-first traversal of the element hierarchy on the structure of the XML document itself. This traversal can be mirrored within an evaluation engine (e.g., evaluator 130) by traversing the nodes of the node tree (e.g., an XPath node tree of a combined equivalent expression) in concert with those of the XML document. A node tree can include a property that any set of nodes in the node tree having the same parent are unique with respect to node type. On the other hand, a node of an XML document can have two or more children of the same type. Thus, for each such visit of a child node having the same type as a child previously visited, the same node in the node tree will be visited. That is, a single node in the node tree is used to represent all nodes of the same type for each unique path from the root node to the node(s) in question.

It may be that each node in the node tree is associated with a list of pointers that identify either logical terms to be evaluated in the context of that node (within the XML document) or leaf nodes of arithmetic expressions. When a node in the XML document is visited, its contents are scanned into a temporary buffer. All expressions pointed to by its mirror node in the node tree (XPath node tree) are evaluated using the contents of this buffer and their results (TRUE or FALSE) are recorded.

When the scope of the root of an arithmetic expression is first entered, the value of all nodes in that expression can be set to the undefined state. For leaf nodes of arithmetic expressions, the node value referred to, either node text or attribute value, can then be used to fill in the value of a leaf in an arithmetic expression. The arithmetic expression is can then be (re)evaluated to determine if its (root) value has changed.

Evaluations can be performed as follows: When the value of a node has changed examine its parent. If the parent has another child whose value is not undefined, then re-evaluate the parent node. If the result of the parent has changed, recursively visit its parent and so on until either an ancestor with an undefined child is reached or the root node is reached. If the root node is reached, (re)evaluate the logical expression for which this root node is a term just as if we were currently in the context of that ancestor node.

Method 200 includes an act of returning a logical TRUE value for any of the plurality of filtering expressions that are satisfied (act 206). For example, evaluator 103 can generated results 127 for combined equivalent expression 127. Evaluator 103 can set return a logical TRUE for value 134 indicating that expression 124 was satisfied by the contents of XML document 121. On the other hand, Evaluator 103 can return a logical FALSE for value 133 indicating that expression 123 was not satisfied by the contents of XML document 121

In some embodiments, there is a one-to-one correspondence between pointers in the (XPath) node tree and the terms of the individual conjunctions comprising (XPath) expressions. Conjunctions can have associated bit fields with a bit for each term in the conjunction. The bit field can be used to keep track of the progress that has been made in proving its associated conjunction TRUE against the current XML document When a term is evaluated with boolean result TRUE, its corresponding bit is set to TRUE to record this fact. If, at any point in the evaluation, all the bits for a conjunction are set, then the rule with which that conjunction is associated is marked as true for the entire XML document.

Method 200 includes an act of delivering the XML document to the corresponding component for each of the plurality of filtering expressions that was returned a logical TRUE value (act 207). For example, results 127 can be sent to delivery module 106. Delivery module 106 can receive results 127. Delivery module 106 can scan results 127 for TRUE values and can match a corresponding expression to the component that sent the expression to filtering module 101. For example, delivery module 106 can identify that value 134 is TRUE. In response, delivery module 106 can determine that registered component 112 sent expression 124 to filtering module 101. Delivery module 106 can then deliver XML document 121 to registered component 112.

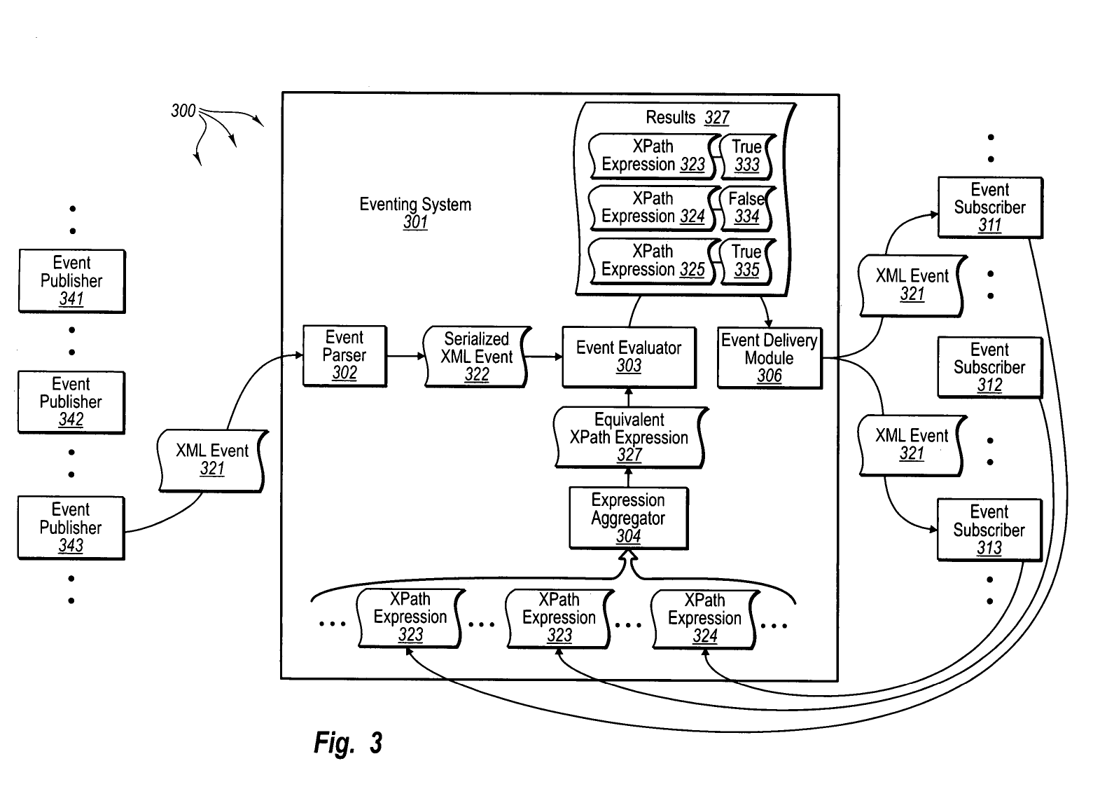

FIG. 3 illustrates an example computer architecture 300 that facilitates evaluating multiple XPath expressions in parallel in an event delivery system. Computer architecture 300 includes a plurality of event publishers including event publishers 341, 342, and 343. From time to time, event publishers can publish XML events to eventing system 301. For example, memory driver can publish XML events related to memory utilization, a printer subsystem can publish XML events related to printer operations, etc.

Computer architecture 300 also includes a plurality of event subscribers including event subscribers 311, 312, and 313. Event subscribers can register with eventing system 301 to received specified types of events. For example, different modules of an operating system can register for events related to system errors, a client printing program can register for events that indicate when a document has completed printing, etc. To register with eventing system 301, an event subscriber can provide event delivery module with an XPath expression indicating events of interest to the event subscriber. For example, event subscribers 311, 312, and 313 can provide XPath expressions 323, 324, and 325 respectively.

Event parser 302 is configured to serialize XML events into serialized XML events. For example, parser 302 can serialize XML event 321 into serialized XML event 322. Event parser 302 can send serialized XML events to event evaluator 303. For example, parser 302 can send serialized XML event 322 to event evaluator 303.

Expression aggregator 304 is configured to aggregate a plurality of XPath expressions into an equivalent XPath expression. For example, expression aggregator 304 can aggregate XPath expressions 323, 324, and 326 into equivalent XPath expression 327. As previously described, aggregation rules can be used to increase the likelihood of various different aggregations being consistent with one another.

Event evaluator 303 is configured to receive a serialized XML event and an equivalent XPath expression, evaluate the equivalent XPath expression against the serialized XML event, and provide results indicating matches to XPath expressions received from registered components. For example, event evaluator 303 can receive serialized XML event 322 and equivalent XPath expression 327. Event evaluator 303 can evaluate equivalent XPath expression 327 against serialized XML event 322. For example, event evaluator can make a single forward pass through serialized XML event 322 comparing the contents of XML event 322 to equivalent XPath expression 327.

Based on the evaluation, event evaluator 303 can produce results 327 indicating whether XML event 321 matched one or more of the XPath expressions 323, 324, and 326. For example, values 333 and 335 are TRUE indicating that XML event 321 matched XPath expressions 323 and 326. On the other hand, value 334 is FALSE indicating that XML event 324 did not match XPath expression 324. Event evaluator 303 can provide results 327 to event delivery module 306.

Event delivery module 306 is configured to receive results, based on the results identify event subscribers that are to receive an XML event, and delivery a copy of the XML event to the identified event subscribers. For example, event delivery module 306 can received results 327, determine that expressions 323 and 326 correspond to event subscribers 311 and 313 respectively, and delivery a copy of XML event 321 to each of event subscribers 311 and 313.

Accordingly, embodiments of the present invention facilitate parallel evaluation of a plurality filtering expressions in a single forward pass through evaluated data. Parallel evaluation results in more efficient filtering, in turn increasing system performance. This efficiency can be particularly advantageous in systems that process a significant number of filtering operations, such as, for example, event delivery systems,

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a computer system, a method for evaluating multiple data filtering expressions in parallel, the method comprising:
an act of accessing an XML document containing a plurality of XML elements;
an act of serializing the XML document into serialized XML;
an act of accessing a plurality of filtering expressions, each filtering expression corresponding to a component that is potentially interested in receiving the XML document;
an act of aggregating the plurality of filtering expression into a single equivalent filtering expression;
an act of evaluating the equivalent filtering expression over the serialized XML in a single pass;
an act of returning a logical TRUE value for any of the plurality of filtering expressions that are satisfied; and
an act of delivering the XML document to the corresponding component for each of the plurality of filtering expressions that was returned a logical TRUE value.

2. The method as recited in claim 1, wherein the act of accessing an XML document containing a plurality of XML elements comprises an act of accessing a XML representation of a computer system event.

3. The method as recited in claim 1, wherein the act of aggregating the plurality of filtering expression into a single equivalent filtering expression comprises an act of aggregating the plurality of filtering expression into a single equivalent filtering expression in accordance with aggregation rules.

4. The method as recited in claim 1, wherein the act of aggregating the plurality of filtering expression into a single equivalent filtering expression comprises an act of aggregating the plurality of filtering expressions into a tree of nodes representing various scopes of the plurality of filtering expressions.

5. The method as recited in claim 1, wherein the act of evaluating the equivalent filtering expression over the serialized XML in a single pass comprises an act of performing an in-order depth-first traversal of the element hierarchy of the single equivalent filter expression on the structure of the XML document.

6. The method as recited in claim 1, wherein the act of returning a logical TRUE value for any of the plurality of filtering expressions that are satisfied comprises an at of producing results indicative of whether or not each of the plurality of filtering expressions was satisfied by XML document.

7. The method as recited in claim 1, wherein the act of delivering the XML document to the corresponding component for each of the plurality of filtering expressions that was returned a logical TRUE value comprises an act of delivering a copy of an XML event to at least one event subscriber.

8. At a computer system including an event delivery system, a method for evaluating multiple XPath expressions in parallel to identify event subscribers that are to receive an XML event, the method comprising:
an act of accessing an XML event containing a plurality of XML elements, the XML event sent from an event publisher;
an act of serializing the XML event into a serialized XML event;
an act of accessing a plurality of XPath filtering expressions, each XPath filtering expression corresponding to an event subscriber interested in receiving XML events that satisfy the XPath filtering expression;
an act of aggregating the plurality of XPath filtering expressions into a single equivalent XPath filtering expression;
an act of evaluating the single equivalent XPath filtering expression over the serialized XML event in a single pass to determine if the serialized XML event satisfies any of the plurality of XPath filtering expressions;
an act of returning a logical TRUE value for any of the plurality of XPath filtering expressions that are satisfied by the XML event; and
an act of delivering a copy of the XML event to the corresponding event subscriber for each of the plurality of filtering expressions that was returned a logical TRUE value.

9. The method as recited in claim 8, further comprising:
an act of receiving an XPath filtering expression for an event subscriber during a registration process by the event subscriber.

10. The method as recited in claim 8, wherein the act of accessing an XML event comprises an act of accessing an XML that was published by one of a plurality of event publishers at the computer system.

11. The method as recited in claim 8, wherein the act of aggregating the plurality of XPath filtering expressions into a single equivalent XPath filtering expression comprises an act of aggregating the plurality of XPath filtering expressions into a single equivalent filtering expression in accordance with XPath aggregation rules.

12. The method as recited in claim 8, wherein the act of aggregating the plurality of XPath filtering expressions into a single equivalent XPath filtering expression comprises an act of aggregating the plurality of XPath filtering expressions into a tree of nodes representing various scopes of the plurality of XPath filtering expressions.

13. The method as recited in claim 12, wherein the act of aggregating the plurality of XPath filtering expressions into a tree of nodes representing various scopes of the plurality of XPath filtering expressions comprises an act of creating a tree of nodes wherein each node of tree is associated with a list of pointers to leaf nodes of arithmetic expressions.

14. The method as recited in claim 8, wherein the act of evaluating the single equivalent XPath filtering expression over the serialized XML event in a single pass comprises act of performing an in-order depth-first traversal of the element hierarchy of the single equivalent XPath filtering expression on the structure of the XML event.

15. The method as recited in claim 8, wherein the act of returning a logical TRUE value for any of the plurality of XPath filtering expressions that are satisfied by the XML event comprises an act of returning a TRUE value for one of the plurality of XPath instructions when each conjunction of XPath expression is TRUE

16. The method as recited in claim 8, wherein the act of returning a logical TRUE value for any of the plurality of XPath filtering expressions that are satisfied by the XML event comprises an act of producing results indicative of whether or not each of the plurality of XPath filtering expressions was satisfied by XML event.

17. A computer system, comprising:
one or more processors;
system memory;
one or more computer-readable media having stored thereon computer-executable instructions representing an event delivery system that, when executed by one of the processors, cause the computer system to perform the following:
access an XML event containing a plurality of XML elements, the XML event sent from an event publisher;
serialize the XML event into a serialized XML event;
access a plurality of XPath filtering expressions, each XPath filtering expression corresponding to an event subscriber interested in receiving XML events that satisfy the XPath filtering expression;
aggregate the plurality of XPath filtering expressions into a single equivalent XPath filtering expression;
evaluate the single equivalent XPath filtering expression over the serialized XML event in a single pass to determine if the serialized XML event satisfies any of the plurality of XPath filtering expressions;
return a logical TRUE value for any of the plurality of XPath filtering expressions that are satisfied by the XML even; and
deliver a copy of the XML event to the corresponding event subscriber for each of the plurality of filtering expressions that was returned a logical TRUE value.

18. The system as recited in claim 17, wherein computer-executable instructions that, when executed, cause the computer system to aggregate the plurality of XPath filtering expressions into a single equivalent XPath filtering expression comprise computer-executable instructions that, when executed, cause the computer system to aggregate the plurality of XPath filtering expressions into a single equivalent XPath filtering expression in accordance with XPath aggregations rules.

19. The system as recited in claim 17, wherein computer-executable instructions that, when executed, cause the computer system to aggregate the plurality of XPath filtering expressions into a single equivalent XPath filtering expression comprise computer-executable instructions that, when executed, cause the computer system to aggregate the plurality of XPath filtering expressions into a tree of nodes representing various scopes of the plurality of XPath filtering expressions.

20. The system as recited in claim 17, wherein computer-executable instructions that, when executed, cause the computer system to evaluate the single equivalent XPath filtering expression over the serialized XML event in a single pass comprise computer-executable instructions that, when executed, cause the computer system to perform an in-order depth-first traversal of the element hierarchy of the single equivalent XPath filtering expression on the structure of the XML event.
